(19) United States
(12) Patent Application Publication
(10) Pub. No.: US 2007/0016334 A1
(43) Pub. Date: Jan. 18, 2007

(54) Method and system for transmitting and utilizing forecast meteorological data for irrigation controllers

(76) Inventors: Brian J. Smith, Aliso Viejo, CA (US); Eric Schafer, Carlsbad, CA (US); George S. Kardaras, Los Angeles, CA (US); Amir Hajizadeh, Long Beach, CA (US)

Correspondence Address: POSZ LAW GROUP, PLC, 12040 SOUTH LAKES DRIVE, SUITE 101, RESTON, VA, 20191, US

(21) Appl. No.: 11/169,803

(22) Filed: Jun. 30, 2005

(51) Int. Cl. G05D 11/00

(52) U.S. Cl. 700/284; 239/69; 702/3; 700/282; 700/283

(57) ABSTRACT

An irrigation controller (101a, 101b) includes a receiver (105a, 105b) and a processor. The processor is configured to facilitate receiving, in accordance with the receiver, an indication of rainfall which is forecast to fall on one or more locations (109a, 109b). Further, the processor is programmed to determine a minimum allowable water level and an optimal water level at the locations (109a, 109b). The processor is also programmed to determine water available at the locations (109a, 109b). In addition, the processor is programmed to determine an amount of water to be delivered so that the water available and the forecast rainfall exceed the minimum allowable water level, and avoid exceeding the optimal water level.

### BACKGROUND OF THE INVENTION

1. Field of the Invention

The present invention relates to systems for irrigation management and control. More particularly, the present invention relates to the utilization of forecast data relating to meteorological conditions, e.g., precipitation, in connection with irrigation.

2. Description of the Related Art

Most modern irrigation controllers include embedded computer processors, designed to execute pre-determined watering schedules in an effort to optimize the water available in the soil, reduce hands-on maintenance, and properly manage the use of water resources. Many conventional irrigation controllers can be connected, either directly or indirectly, to sensors that measure actual water usage, actual rainfall, and various other actual measured meteorological data. The actual measured meteorological data collected by the sensors can be incorporated into the watering schedules in an effort to improve their accuracy.

One conventional irrigation variable that can be used by irrigation controllers is evapotranspiration (“ET”). ET is water loss due to the combination of evaporation from the soil surface and/or plant leaf, and water actually absorbed and used by the plant. Because measuring ET directly can be difficult, expensive and time consuming, ET typically is estimated by a calculation utilizing actual measured meteorological data. One common calculation for ET uses measured weather data: temperature, relative humidity, solar radiation, and wind.

### BRIEF DESCRIPTION OF THE SEVERAL VIEWS OF THE DRAWING(S)

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a diagram illustrating a simplified and representative environment associated with an exemplary system for facilitating irrigation in accordance with various exemplary embodiments;

FIG. 2 is a diagram illustrating an alternative simplified and representative environment associated with an alternative exemplary system for facilitating irrigation in accordance with various exemplary embodiments;

FIG. 3 is a block diagram illustrating portions of an exemplary irrigation controller in accordance with various exemplary embodiments;

FIG. 4 is a flow chart illustrating an exemplary procedure for delivering water via irrigation devices in accordance with various exemplary and alternative exemplary embodiments;

FIG. 5 is a flow chart illustrating an exemplary procedure for facilitating irrigation in accordance with various exemplary and alternative exemplary embodiments; and

FIG. 6 is a flow chart illustrating an exemplary evapotranspiration/rainfall update procedure, in accordance with various exemplary embodiments.

### DETAILED DESCRIPTION OF THE INVENTION

In overview, the present disclosure concerns irrigation controllers, irrigation devices, or irrigation systems, often referred to as irrigation controllers, and the like having a capability to control irrigation. Such irrigation systems may further be connected electrically, electronically or mechanically to: sensors for collecting actual meteorological data, watering devices such as sprinklers or the like for applying water, and/or receivers/transmitters for communicating with typical components of the irrigation system such as other irrigation controllers, servers, and/or master computers and optionally receiving and/or transmitting in accordance with a communication network and/or computer network. More particularly, various inventive concepts and principles are embodied in irrigation systems, irrigation controllers, parts thereof, and/or methods therein for transmitting and/or utilizing forecast meteorological data associated with irrigation.

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore or application specific ICs. The processor can be, for example, a general purpose computer, can be a specially programmed special purpose computer, can include a distributed computer system, and/or can include embedded computer processors. Similarly, the processing could be controlled by software instructions on one or more computer systems or processors, or could be partially or wholly implemented in hardware. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the preferred embodiments.

As further discussed herein below, various inventive principles and combinations thereof are advantageously employed to utilize forecast meteorological data in connection with irrigation systems. Because the conventional calculation for evapotranspiration (“ET”) uses actual data, it can be an imperfect model of future irrigation needs. However, aspects of irrigation can be improved by taking into consideration forecast meteorological data.

Further in accordance with exemplary embodiments, there is provided an irrigation control system with an ability to receive and react to forecast meteorological data. This can be implemented on a microprocessor-based irrigation controller with a communication port, or on other embodiments such as those provided herein by way of example. The forecast meteorological data can be obtained by one or more irrigation controllers in the irrigation control system, for example from a remote source on a periodic basis or in response to a request by the irrigation controller. The remote source can take a variety of forms, such as a remote irrigation controller in a peer to peer irrigation control network, a server communicating through the internet, a master computer in a master-slave irrigation control network, a personal or handheld computer communicating with an irrigation control system, or similar.

One of the goals of an irrigation system can be to replace water lost due to ET. If the amount of water delivered by the watering devices is known, and if forecast rainfall data and forecast or actual ET data is available, an irrigation system can replace the lost water into the soil on a periodic (typically daily) basis, achieving a desired level of water in the soil while reducing the use of water provided through irrigation.

Rainfall data is not best used in currently available irrigation systems. Actual rainfall can be measured and adjusted for by the irrigation system in replacing previously or currently lost ET water. Nevertheless, rainfall can exceed what can be adequately absorbed by the soil, thereby causing the soil to saturate and runoff, losing what is effectively free water.

Soil at a particular location can be associated with a normal water level (which provides a safe amount of stored water), a minimum water level (below which the plants are adversely affected), and a maximum water level (at which point additional water cannot be stored by the soil and becomes runoff). In accordance with one or more embodiments, the various water levels can be pre-determined, e.g., by a user, and/or can be averaged over time, and/or can be developed by adjusting from actual measurements, and/or can be associated with periods of time, e.g., monthly or seasonally. Rainfall that exceeds the difference between the maximum level and the normal level becomes runoff:
Lost Water Rainfall−(Max Soil Water−Normal Soil Water) (1)
where
Lost Water=amount of runoff
Max Soil Water=maximum water level
Normal Soil Water=normal soil water level
Rainfall=measured rainfall

In practical terms, lost water can also be affected by other meteorological data and/or soil conditions, such as the rainfall rate and the rate at which soil can absorb water, humidity, temperature, wind speed, and the like. Humidity and temperature are generally encompassed by evapotranspiration, although rainfall rate and wind speed generally are not ET-related. A determination of an amount of water to be delivered and/or the timing of the delivery of the water can take into consideration one or more of these other non-ET related forecast meteorological data and/or soil conditions, or a combination thereof.

For simplicity, the following example is limited to the considerations in equation (1) above. Consider, for example, soil with the following characteristics:
Normal water level in root zone=1 inch
Minimum water level=0.3 inches
Saturation water level=2 inches

If 1.5 inches of rainfall occurred on the next day, lost water (runoff) for the next day would be 0.5 inches:
Lost Water=1.5(2.0-1.0) (2)

Because conventional ET based systems use current or historical ET data and rainfall measurements, runoff due to rainfall is likely to occur. However, by anticipating meteorological conditions such as rainfall, one or more embodiments can allow the water available to deplete below the normal level in order to be able to absorb free water (e.g., rainfall). Alternative embodiments can provide that the water available not be allowed to deplete below the minimum level.

Still referring to the above example, one or more embodiments can receive an indication that 1.5 inches of rainfall can be expected on a particular day in the future. On one or more days prior to the particular day, the irrigation can be reduced or omitted in order to deplete the soil. Consequently, on the particular day, rainfall that occurs will be added to the water stored in the soil and runoff thereby can be reduced or eliminated.

In accordance with one or more embodiments, where the forecast rainfall amount is inaccurate, e.g., in comparison to the actual measured rainfall amount, where forecast rainfall does not occur, or where the rate of rainfall was so fast as to cause runoff, the water available stored in the soil can be restored before the minimum level is reached, e.g., by making up the difference through additional irrigation or during one or more subsequent normally scheduled cycles of irrigation cycle.

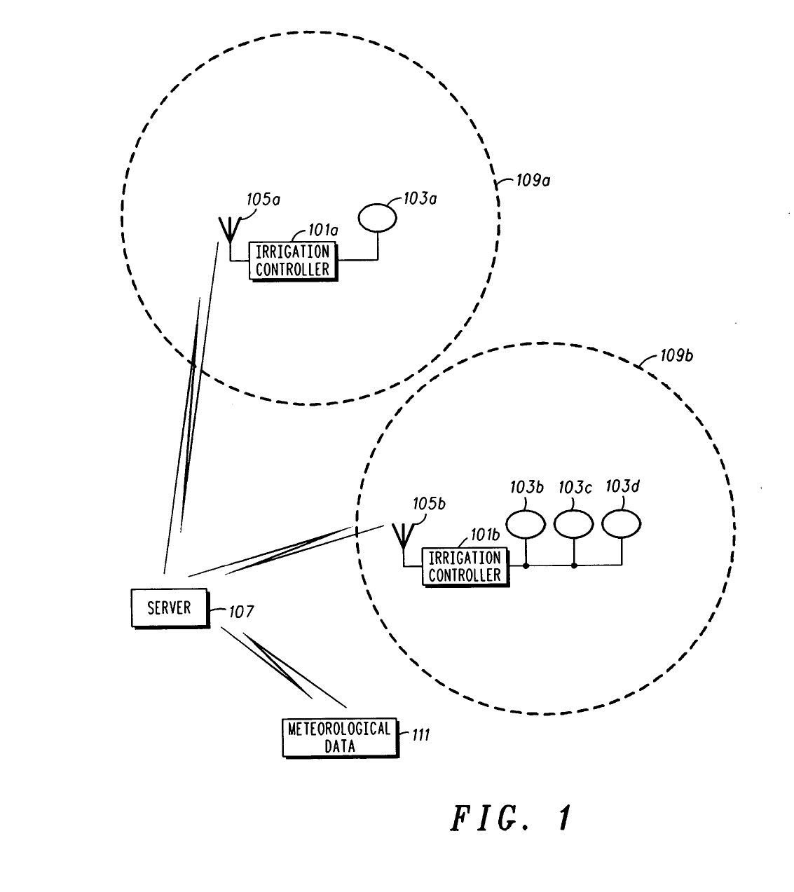

Referring now to FIG. 1, a diagram illustrating a simplified and representative environment associated with an exemplary system for facilitating irrigation in accordance with various exemplary embodiments will be discussed and described. In the illustration there are first and second irrigation controllers 101a, 101b, representative of one or more irrigation controllers which can be provided; a server 107 communicating with the irrigation controllers 101a, 101 b; and a storage of meteorological data 111, in communication with the server 107.

The first and second irrigation controllers 101a, 101b can include a transceiver 105a, 105b for receiving and/or transmitting information to the server 107. Also, the first and second irrigation controllers 101a, 101b can be associated with one or more watering devices 103a-d. Each irrigation controller 101a, 101b and/or the watering devices 103a-d associated therewith can be associated with a particular location 109a, 109b.

The locations 109a, 109b are represented in the illustration as circular, however, they can be any shape (e.g., polygonal) or size appropriate to a particular climate or micro-climate. Moreover, the locations can overlap, be adjacent, spaced apart, and/or any combination thereof. Generally, a location can be characterized in that it can have the same amount of water available and/or water levels throughout, e.g., minimum allowable water level, optimal water level. Moreover, a location can be determined by, e.g., manual selection, automatic grouping together of irrigation devices that have sufficiently the same water available and/or water levels, automatic grouping together of irrigation devices in geographic proximity, and/or a combination thereof. One or more irrigation controllers can be associated with a location.

The server 107 as illustrated can obtain the meteorological data 111 via a communication. Alternatively, the meteorological data 111 can be provided on the server 107, e.g., as a local database or similar. Moreover, any type of communication can be utilized by the server 107 in order to obtain the meteorological data 111.

The server 107 can determine irrigation controllers and locations corresponding thereto, and provide appropriate meteorological data to the irrigation controllers. For example, the server 107 can have a list of irrigation controllers with which it can communicate.

After obtaining meteorological data 111, e.g., forecast data and optionally current data, the server 107 can select portions of the data corresponding to irrigation controllers, based on location. Further, the server 107 can select only relevant portions of the data considering determinations to be made at the irrigation controllers, e.g., the server 107 can select forecast rainfall and/or other data which can affect water available, water levels and/or other desired forecast meteorological data. The selected data can be transmitted from the server 107 to the irrigation controllers 101a, 101 b.

The irrigation controllers 101a, 101b can have a watering schedule stored or programmed therein, in accordance with known techniques. The irrigation controllers 101a, 101b can evaluate their respective current and/or future watering schedules in view of the forecast meteorological data, e.g., to accommodate ET while reducing or eliminating irrigation in view of forecast rainfall, to accelerate a watering schedule in view of forecast high winds, etc.

In accordance with one or more embodiments, the irrigation controllers 101a, 101b can be configured automatically, semi-automatically or manually (by the user) with relevant data such as sprinkler precipitation rate, current water available in the root zone, maximum water level the soil can hold, minimum water level before plant damage, and optimal water level.

Accordingly, one or more embodiments provides an irrigation controller. The irrigation controller comprises a receiver, and a processor. The processor can be configured to facilitate receiving, in accordance with the receiver, an indication of rainfall which is forecast to fall on at least one location; first determining a minimum allowable water level and an optimal water level at the at least one location; second determining water available at the at least one location; and third determining an amount of water to be delivered so that the water available and the forecast rainfall exceed the minimum allowable water level, and avoid exceeding the optimal water level. Moreover, one or more embodiments provides that the processor stores an indication of its location, which is utilized as the at least one location. Alternatively, such as where the processor is not at the location where the water device is located, the processor can store a pre-determined indication of location, which is utilized as the at least one location.

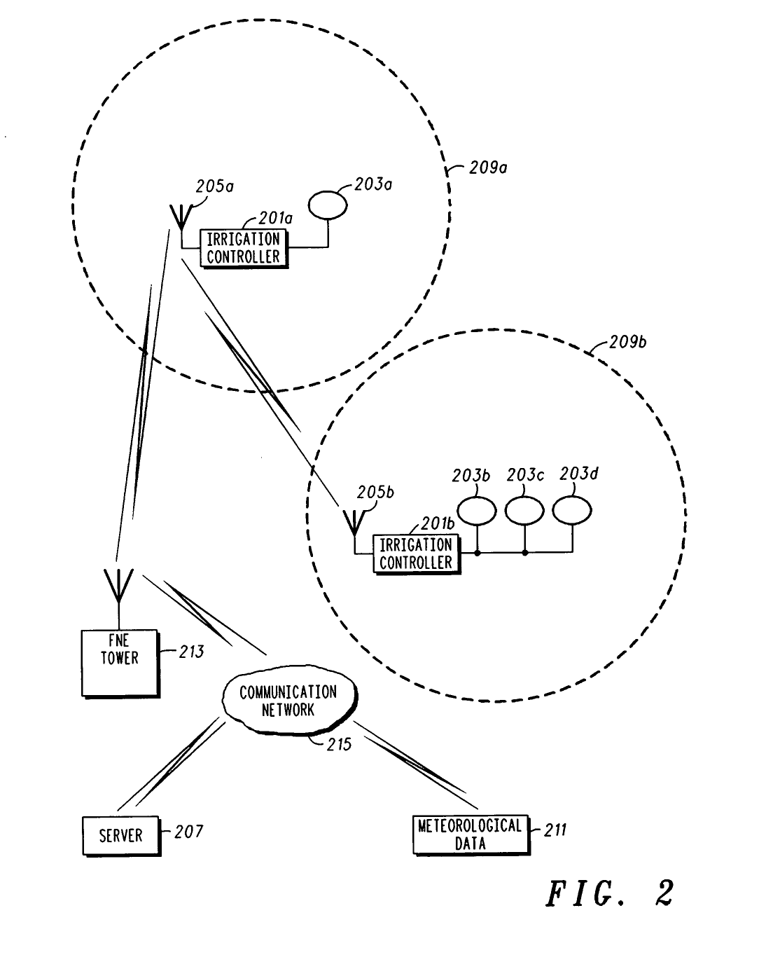

Referring now to FIG. 2, a diagram illustrating an alternative simplified and representative environment associated with an alternative exemplary system for facilitating irrigation in accordance with various exemplary embodiments will be discussed and described. In this illustrated embodiment, there are provided first and second irrigation controllers 201a, 201b, representative of one or more irrigation controllers; a server 207 communicating with the first irrigation controller 201a; and a storage holding, e.g., meteorological data 211. Communication in the illustrated embodiment is via a communication network 215 such as the Internet and a cellular or dispatch network, represented here by a fixed network equipment (FNE) tower 213.

The first and second irrigation controllers 201a, 201b can include a transceiver 205a, 205b for receiving and optionally transmitting information between each other and to/from the server 207. Also, the first and second irrigation controllers 201a, 201b can be associated with one or more watering devices 203a-d and a particular location 209a, 209b.

The server 207 is illustrated as obtaining the meteorological data 211 via a communication network 215. However, any type of communication can be provided.

As described above, the server 207 can determine irrigation controllers and locations corresponding thereto, and send meteorological data appropriate to irrigation controllers. Moreover, the server 207 can select portions of the data corresponding to irrigation controllers and send just selected portions of the data.

The selected data for the first and second irrigation controllers 201a, 201 b can be transmitted from the server 207 to the first irrigation controller 201a, and in the illustrated embodiment, the first irrigation controller 201a can forward appropriate data intended for the second irrigation controller 201b.

The server 207 can transform the data to be transmitted to a format appropriate for a cellular call or dispatch call, and can send the requested call to the irrigation controllers, e.g., first irrigation controller 201a, via a communication network 215. The communication network 215 transmits the call in accordance with its usual procedures, which can include for example the fixed network equipment (FNE), represented in FIG. 2 by an FNE tower 213. The call with the data is received by one or more irrigation controllers, e.g., the first irrigation controller 201a.

The irrigation controllers 201a, 201b can have a watering schedule, soil condition information, and other relevant data, and can evaluate their respective watering schedules and (optionally) soil condition information in view of the forecast data to accommodate ET while reducing, re-scheduling or eliminating irrigation.

One or more alternative embodiments provide that the server 207 has the water schedules for the irrigation controllers 201a, 201b. The server 207 evaluates the watering schedules in view of the forecast data to accommodate ET. The server 207 can provide updates of the watering schedules to the irrigation controllers 201a, 201b.

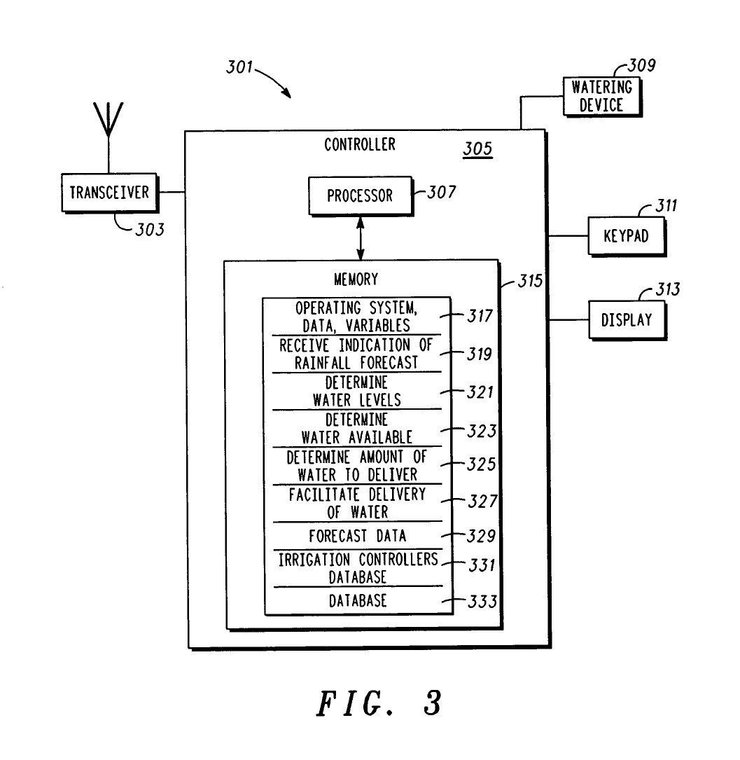

Referring now to FIG. 3, a block diagram illustrating portions of an exemplary irrigation controller in accordance with various exemplary embodiments will be discussed and described.

The irrigation controller 301 may include a controller 305, a transceiver 303, and can communicate with an external device such as a watering device 309. The controller 305 as depicted generally includes a processor 307, and a memory 315, and may include other functionality not illustrated for the sake of simplicity. The irrigation controller may further include, e.g., a text and/or image display 307, and/or a user input device such as a keypad 311. The transceiver 303 alternately can include a transmitter and/or a receiver.

The processor 307 may comprise one or more microprocessors and/or one or more digital signal processors. The memory 315 may be coupled to the processor 307 and may comprise a read-only memory (ROM), a random-access memory (RAM), a programmable ROM (PROM), and/or an electrically erasable read-only memory (EEPROM). The memory 315 may include multiple memory locations for storing, among other things, an operating system, data and variables 317 for programs executed by the processor 307; computer programs for causing the processor to operate in connection with various functions such as receiving indications of rainfall forecast 319, determining water levels 321, determining water available 323, determining an amount of water to deliver 325, facilitating delivery of water 327, and/or other processing (not illustrated); storage for the forecast data 329; an irrigation controllers database 331; and a database 333 for other information used by the processor 307 such as watering schedules and soil condition information. The computer programs may be stored, for example, in ROM or PROM and may direct the processor 307 in controlling the operation of the irrigation controller 301.

The processor 307 can use a timer or other clock source to keep track of time, and when the start time of a watering schedule is recognized, the processor 307 can retrieve the watering schedule from memory, and deliver a particular amount of water via the watering device 309. Delivering the particular amount of water via the watering device 309 can be performed in accordance with known techniques, for example, the processor 307 can assert one or more states of a valve output driver to a sprinkler.

Further, the processor 307 can be programmed for receiving indications of rainfall forecast 319 or other forecast meteorological data. For example, the processor 307 may be programmed to receive communications from a communication network in accordance with the transceiver 303. Communications can include, e.g., meteorological data for use by the processor. The communications containing the forecast can be received upon demand by the processor, or asynchronously without a corresponding demand. Accordingly, one or more embodiments can provide that the device includes at least one transmitter, wherein the processor is further configured to facilitate causing the transmitter to transmit a request for a forecast, responsive to a schedule. According to one or more embodiments, the meteorological data was previously selected before being transmitted, as being useful to the particular processor. For example, the meteorological data can correspond to particular irrigation controllers, based on location. As another example, the meteorological data which is included in the communication can be utilized by determinations made at the processor 307, e.g., forecast rainfall and/or other data which can affect water available and/or water level. According to one or more alternative embodiments, the meteorological data is not limited to data useful to the particular processor 307, for example, the processor 307 can be further programmed to select portions of data relevant to the processor's determinations from the received meteorological data.

The processor 307 can be programmed for determining water levels 321, such as maximum water level the soil can hold, minimum water level before plant damage, and optimal water level. The water levels can be determined by various manual, automatic, semi-automatic methods, and/or a combination thereof. In accordance with one or more embodiments, for example, water levels can be assigned via manual interaction with a user, such as through a user input device, e.g., the illustrated keypad 311, and display 313. In accordance with alternative embodiments, the water levels can be assigned automatically via receipt in accordance with the transceiver 303 of an instruction indicating one or more assigned water levels, by comparison of water levels in irrigation controllers in a geographic vicinity, and/or can be averaged over time, developed by adjusting from feedback measurements, associated with periods of time, e.g., monthly or seasonally, or the like. In accordance with other alternative embodiments, the water levels can be assigned semi-automatically, e.g., by suggesting a water level which can be adjusted via interaction with the user.

In addition, the processor 307 can be programmed for determining water available 323. Water available can be determined by various conventional techniques for measuring and/or estimating water in the soil. These techniques can include calculations such as are provided by various agricultural entities, and can include various refinements, e.g., considerations for root-zone, soil type, etc.; and/or these techniques can include measurements of soil moisture by one or more sensors at the location, e.g., by a neutron probe, a granular matrix sensor, or similar. Accordingly, one or more embodiments provide that water available is determined responsive to at least one sensor at the at least one location. Alternatively, water available can be determined by the processor 307 obtaining information representing water available, e.g., received from another processor. Accordingly, one or more embodiments provide that the processor 307 receives, in accordance with the receiver, an indication of the water available.

Also, the processor 307 can be programmed for determining an amount of water to deliver 325 and/or when to deliver the amount of water. The determination takes into account the meteorological data such as forecast rainfall (including other precipitation) and/or other forecast data which can affect water available, e.g., wind speed, rate of rainfall, etc. Accordingly, one or more embodiments can provide that the processor is configured so that, if no rainfall is forecast, the amount to be delivered is calculated to restore the optimal water level. According to one or more embodiments, the delivery can be during a particular day in the watering schedule, and the forecast meteorological condition is for at least one day subsequent to the particular day in the watering schedule. Any of several conventional techniques can be utilized to yield an initial determination of an amount of water to deliver which does not take into account the forecast rainfall, or can be modified to take into account the forecast rainfall. Conventionally, a watering schedule is provided which prescribes a particular amount of irrigation which can be utilized as an initial determination of the amount to deliver. Such watering schedules can consider historical information, e.g., past seasonal cycles or past watering requirements. The determination can calculate the amount of water to be delivered so that the water available and the forecast rainfall exceed the minimum allowable water level, and avoid exceeding (to the extent possible) the optimal water level. It is anticipated in some instances that the forecast rainfall will exceed the optimal water level without additional water being delivered by irrigation, in which case no water will be delivered by irrigation.

Moreover, the forecast meteorological data can cover one or more days. Accordingly, one or more embodiments provides that, when the forecast rainfall indicates rain within the next plurality of days, the third determining includes judging the amount of water over the plurality of days. For example, the processor 307 could receive two or more days of forecast rainfall values, and the watering schedule can be adjusted as further described herein for the next two or more days.

The processor 307 can be programmed for facilitating a delivery of the water 327. Accordingly, one or more embodiments provide at least one watering device, wherein the processor is further configured to facilitate the delivery of the amount via the watering device. Techniques are well known for delivering water, e.g., controlling drivers connected to the watering device 309.

The display 313 may present information to the user by way of a conventional liquid crystal display (LCD) and/or other visual display. The user may invoke functions, such as programming the processor 307 or storing water level information, through the user input device 311, which can comprise one or more of various known input devices, such as a keypad 311 as illustrated, a computer mouse, a touchpad, a touch screen, a trackball, and/or a keyboard.

Instructions for implementing some of the foregoing can be provided on various computer-readable mediums. Accordingly, one or more embodiments can provide a computer-readable medium comprising instructions for execution by a computer, the instructions for implementing a computer-implemented method for delivering water via one or more irrigation devices at one or more locations. For example, all or part of the instructions can be provided in any appropriate electronic format, including, for example, provided over a communication line as electronic signals, provided on floppy disk, provided on CD ROM, provided on optical disk memory, or the like.

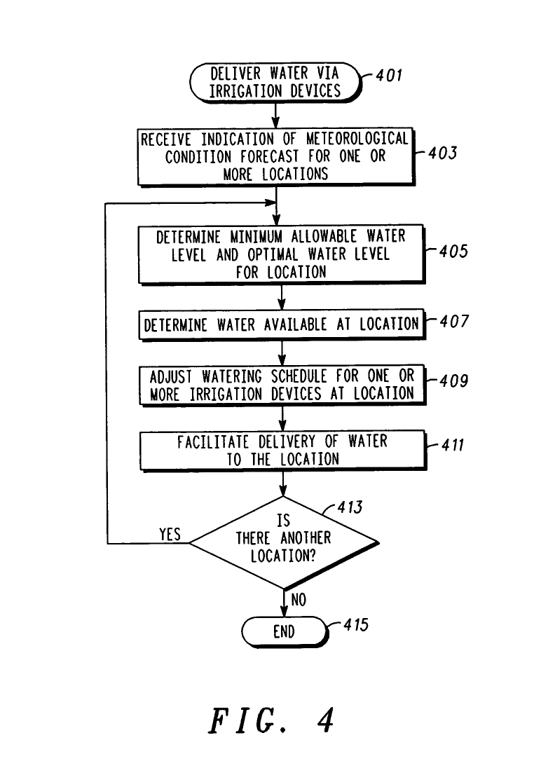

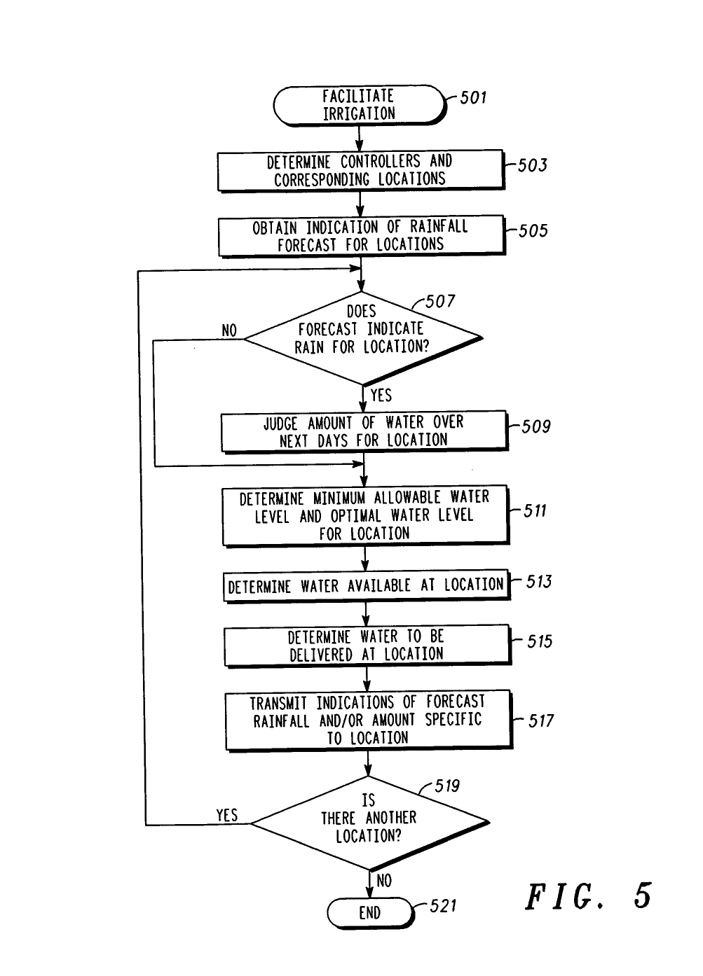

FIG. 4 and FIG. 5 are flow charts illustrating exemplary procedures for delivering water via irrigation devices, and for facilitating irrigation. One or more embodiments of the procedure illustrated in FIG. 4 can advantageously correspond, for example, to a procedure implemented on the irrigation controllers 101a, 101b illustrated in FIG. 1 or the irrigation controllers 205a, 205b illustrated in FIG. 2. One or more embodiments of the procedure illustrated in FIG. 5 can advantageously correspond, for example, to a procedure implemented on the servers 107, 207 illustrated in FIG. 1 and FIG. 2. However, it should be understood that the functionality illustrated in FIG. 4 and FIG. 5 can be distributed in a variety of combinations between various equipment in an irrigation system, and such combinations are encompassed in the scope herein.

Referring now to FIG. 4, a flow chart illustrating an exemplary procedure for delivering water via irrigation devices in accordance with various exemplary and alternative exemplary embodiments will be discussed and described. The procedure can advantageously be implemented on, for example, a processor of an irrigation controller, described in connection with FIG. 3 or other apparatus appropriately arranged.

In overview, the illustrated exemplary procedure for delivering 401 water via irrigation devices can include receiving 403 an indication of a meteorological condition forecast for one or more locations. For the locations of interest, the procedure includes determining 405 minimum allowable water level and optimal water level for the location; determining 407 water available at the location; adjusting 409 the watering schedule for one or more irrigation devices at the location; and facilitating 411 the delivery of water to the location. The foregoing can be repeated for another location if there is another location 413.

Receiving 403 an indication of the meteorological condition forecast for one or more locations has been described above in connection with various embodiments. For example, the indication of rainfall forecast can be included in a communication with forecast precipitation and/or other meteorological data for one or more days and/or one or more locations.

Exemplary illustrations of determining 405 minimum allowable water level and optimal water level for the location have been provided herein. For example, the water levels can be determined manually, automatically, semi-automatically, and/or a by a combination thereof. Moreover, other water levels can be determined according to alternative embodiments, such as normal soil water level; and/or the determining can be limited to, e.g., a pre-defined root-zone.

Various examples of determining 407 water available at the location were previously described in connection with exemplary embodiments. For example, water available can be determined by calculations such as are provided by various agricultural entities; by measurements of soil moisture by one or more sensors; and/or by receiving information representing water available.

One or more embodiments provide for adjusting 409 the watering schedule for one or more irrigation devices at the location. For example, because water available and/or ET can be predicted by reference to the pre-determined watering schedule and the forecast rainfall (or precipitation generally) and/or other forecast meteorological conditions (e.g., wind speed, temperature, humidity), the pre-determined watering schedule can be adjusted to deliver more and/or less water and/or to deliver water at a different timing to accommodate the forecast rainfall and/or other forecast meteorological conditions. In order to accommodate the forecast rainfall and/or other forecast meteorological conditions, the amount of water to be delivered can be decreased or increased so that the rainfall expected to be received (if any) plus the amount of water is more than the minimum allowable water level for the location. If possible, the amount of water to be delivered can be decreased so that the rainfall expected to be received plus the amount of water to be delivered is less than the optimal water level for the location. Similarly, the timing of the watering schedule can be changed to accommodate the forecast meteorological condition. For example, if heavy wind is forecast during a scheduled irrigation, the irrigation can be re-scheduled earlier (or later). The watering schedule can be adjusted in accordance with one or more embodiments by modifying the watering schedule, by providing a watering schedule which is temporarily stored with modified information, by adjusting the amount mandated by the watering schedule when provided on the fly, or similar. Accordingly, one or more embodiments further comprise instructions for adjusting a watering schedule for the one or more irrigation devices.

The procedure also provides for facilitating 411 the delivery of water to the location. As previously described, the delivery of water can be facilitated by known techniques, such as commands relayed to specific watering devices and/or adjusting watering schedules. In accordance with one or more embodiments, the delivery of water may await the appropriate time as defined by the watering schedule. If the meteorological condition indicates that no rainfall is forecast, then the amount of water to be delivered can be calculated to restore the optimal water level. Similarly, if the forecast precipitation is insufficient to restore the optimal water level, then the amount of water to be delivered can be calculated to restore the optimal water level.

In accordance with one or more embodiments, the determination 405 of water levels, determination 407 of water available, adjusting the watering schedule 409, and facilitating 411 delivery of water are repeated for another location if there is another location 413. Otherwise, the procedure can end 415, e.g., until it is once again time to deliver water via the irrigation devices 401.

Accordingly, one or more embodiments provides instructions for implementing the steps of: (A) receiving an indication of a meteorological condition which is forecast to occur on at least one location; (B) determining a minimum allowable water level and an optimal water level at the at least one location; (C) adjusting a watering schedule at the at least one location responsive to the meteorological condition, so that the water available in relation to the meteorological condition exceeds the minimum allowable water level, and avoids exceeding the optimal water level; and (D) facilitating the delivery of an amount of water via the one or more irrigation devices to the at least one location.

Referring now to FIG. 5, a flow chart illustrating an exemplary procedure for facilitating irrigation in accordance with various exemplary and alternative exemplary embodiments will be discussed and described. The procedure can advantageously be implemented on, for example, a processor of a server, described in connection with FIG. 1 and/or FIG. 2, or other apparatus appropriately arranged. For example, some or all of the procedure described herein can be implemented on a processor of an irrigation controller described in connection with FIG. 3.

In overview, the procedure for facilitating irrigation 501 includes determining 503 controllers and locations corresponding thereto; obtaining 505 indications of rainfall forecast for the locations; and for each of the locations, transmitting at least the indication of forecast rainfall. More particularly, transmitting at least the indication of forecast rainfall includes determining whether 507 the forecast indicates rain for the location, and if so, judging 509 the amount of water over the next plurality of days for the location; determining 511 water levels for the location; determining 513 water available at the location; determining 515 water to be delivered at the location; and transmitting 517 indications of forecast rainfall and/or amount specific to the location.

The procedure can provide for determining 503 controllers and locations corresponding thereto. The controllers and corresponding locations can be determined in accordance with various known techniques, e.g., by polling for connected or connectable controllers, by manual entry, etc. For example, a list can be provided of irrigation controllers with which the procedure can communicate, and locations corresponding thereto.

Further, the procedure can provide for obtaining 505 indications of rainfall forecast for the locations. In accordance with one or more embodiments, meteorological data including rainfall forecast can be obtained, e.g., in accordance with known techniques from a server or database containing such data. One or more embodiments can provide for searching the meteorological data to obtain the desired data, e.g., rainfall forecast for the locations.

The procedure also can provide for determining whether 507 the forecast indicates rain for the location, for example by examining the rainfall forecast corresponding to the current location of interest. If the rainfall forecast indicates that rain is expected, then the procedure can provide for judging 509 the amount of water over one or more days. For example, the procedure can judge the amount of water over the next plurality of days for the location. The amount of water can be determined as previously described, for example, so that the water available plus the forecast rainfall are within the bounds established by the water levels (the minimum allowable water level and the optimal water level).

The procedure can provide for determining 511 water levels for the location. For example, various water levels for locations can be pre-determined, e.g., by a user, and/or can be averaged over time, and/or can be developed by adjusting from feedback measurements, and/or can be associated with periods of time, e.g., monthly or seasonally, and/or can be retrieved, e.g. by querying an irrigation controller or from storage.

Also, the procedure can provide for determining 513 water available at the location. As previously explained, water available can be determined by various conventional techniques for defining water in the soil and/or can be retrieved, e.g., by querying an irrigation controller or from storage.

Further, the procedure can provide for determining 515 water to be delivered at the location. As explained above, the amount of water to be delivered takes into account the meteorological data such as forecast rainfall (and/or other precipitation) and/or other forecast data which can affect water available. A calculation of the amount of water to be delivered can consider the forecast precipitation in calculating the amount of water to deliver to maintain water at the location above the minimum allowable water level, and preferably below the optimal water level. The amount of water to be delivered can be determined over periods of time, e.g., a plurality of hours, a plurality of days, where appropriate. For example, the amount of water to be delivered can be determined over three days.

In addition, the procedure can provide for transmitting 517 indications of forecast rainfall and/or amount specific to the location. For example, the procedure can provide for contacting the controllers on a periodic basis, e.g., daily, or when the amount to be delivered at the location is adjusted from the pre-determined amount, or in response to a query from a controller. Whether the indication which is transmitted is forecast rainfall and/or amount can correspond to what the controllers expect to receive. For example, if the controller expects to receive the amount of water to deliver, the controller can transmit the indication of the amount of water. Likewise, if the controller expects to receive the indication of forecast rainfall, the controller can transmit the indication of the forecast rainfall. According to various embodiments, the transmission can include indications of both the amount of water to be delivered and the forecast rainfall. The format of the transmission can correspond to a pre-defined format which is also in use by the controller. For example, the indications can be embedded into a pre-defined transmission message format with additional information, or can be a separate transmission. As another example, indications which are relevant to several controllers can be provided in a single message.

In accordance with one or more embodiments, determinations which are performed by the controllers can be omitted from the procedure. For example, where the controller has information on the water levels and water available, and can determine amount of water to be delivered from the forecast rainfall, the following can be omitted from the procedure: determination 511 of water levels, determination 513 of water available, and determination 515 of water to be delivered.

In accordance with one or more embodiments, the determination 507 of rain forecast, judging 509 the amount of water, determination 511 of water levels, determination 513 of water available, determination 515 of water to be delivered, and transmission 517 of indications of forecast rainfall are repeated for another location if there is another location 519. Otherwise, the procedure can end 521 until it is once again time to facilitate irrigation 501.

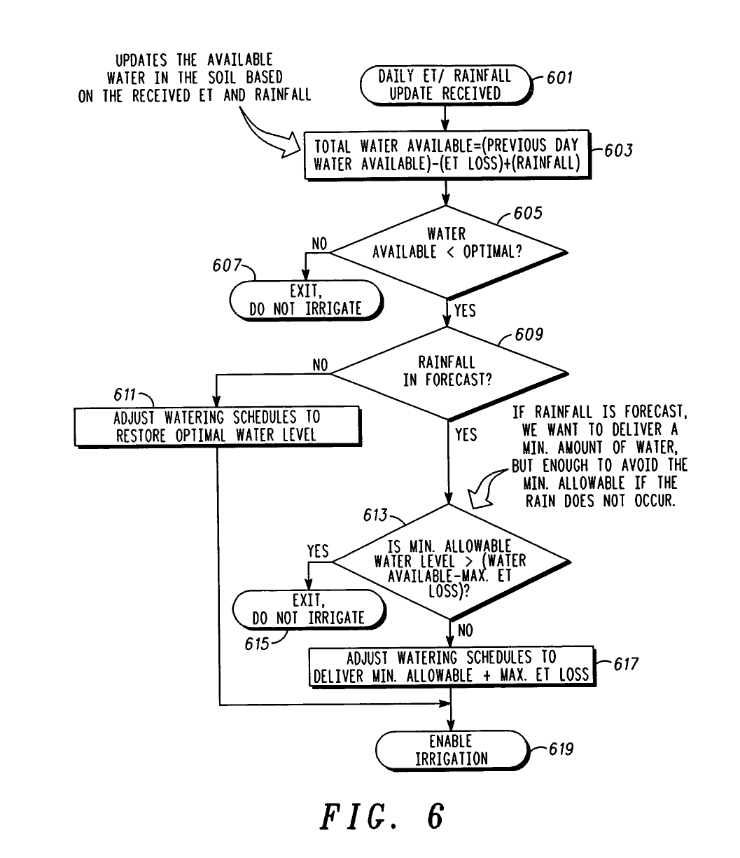

Referring now to FIG. 6, a flow chart illustrating an exemplary evapotranspiration/rainfall update procedure, in accordance with various exemplary embodiments will be discussed and described. The procedure can advantageously be implemented on, for example, a processor of an irrigation controller, described in connection with FIG. 3, or other apparatus appropriately arranged.

FIG. 6 provides an exemplary embodiment of a process for a particular location upon a periodic (e.g., daily) reception of forecast meteorological data. For this example, assume that the forecast meteorological data contains yesterday's measured ET and rainfall, plus at least the forecast precipitation (e.g., rainfall) for the next three days. The process attempts to maintain water available close to or at the optimal water level by adjusting the watering schedule to return water lost from the previous day. Accordingly, the process can provide that the water available is determined to be water available for the previous time period minus the evapotranspiration loss plus an amount of actual rainfall.

When it is determined that rain is forecasted over the next three days, the process can attempt to reduce the water available to a safe amount (i.e., not less than the minimum allowable water level) such that rainfall can be absorbed, without runoff if possible. Accordingly, if the evapotranspiration level will reduce the water available to at least the minimum allowable water level during the watering schedule, the watering schedule is adjusted to deliver the minimum allowable plus a maximum evapotranspiration loss. The following equation can ensure that the minimum safe amount of water available is always maintained when trying to dry out in anticipation of the rain. In this example, the process can test the condition:
Minimum Water Level>(Current Water Available−Max ET loss) (3)
where the (Max ET loss) can be defined as the value for maximum ET loss observed, e.g., in a yearly historical record. If the condition is true, then an amount of water needs to be added, e.g., by irrigation and/or rainfall.

The illustrated example process provides for receiving 601 daily ET/rainfall update. Accordingly, one or more embodiments can provide for receiving an indication of evapotranspiration loss. Also, one or more embodiments can provide for receiving an indication of the amount of actual rainfall. The process then calculates the water available 603, e.g., by setting the total water available=(previous day water available)−(ET loss)+actual rainfall. This updates the indication of water available in the soil, based on the received ET and the actual rainfall.

The process then can check 605 whether the calculated water available is less than the optimal water level. If there is the water available is more than the optimal water level, there is no need for irrigation, and the process can exit 607. Otherwise, an amount of water needs to be provided. The remainder of the discussion of this process then assumes that the amount of water needs to be provided, whether by precipitation or irrigation.

The process then checks 609 whether there is rainfall in the forecast. If there is no rainfall in the forecast, the process adjusts 611 the watering schedule (or schedules) so that the irrigation will restore the water available to the optimal water level. Having adjusted the watering schedule(s), irrigation can be enabled 619, e.g., in accordance with known techniques.

If there is rainfall in the forecast, however, the process provides for delivering an amount of water sufficient to avoid runoff, but which at least meets the minimum allowable water level if the forecast rainfall does not actually fall. As illustrated, the process checks 613 whether the minimum allowable water level is more than (water available−maximum ET loss). If so, irrigation is not needed, and the process can exit 615 without causing irrigation. Otherwise, irrigation is needed. The process then adjusts 617 the watering schedule(s) to deliver (minimum allowable water loss+the maximum ET loss); and then enables 619 irrigation as discussed above.

One or more embodiments of the present invention have been illustrated in simplified format. The illustrations are intended as examples, and will be understood to include equivalents. For example, the server can be omitted from the system. Further, it is not intended to limit the present invention to the particular number of irrigation controllers illustrated, or the particular communication networks illustrated. One or more embodiments of the present invention may operate in connection with various other combinations of the same, and/or equivalents thereof.

The term meteorological data, as used herein, is intended to encompass data the represents or indicates one or more meteorological conditions, including by way of example, rainfall (or precipitation), temperature, humidity, wind speed, and evapotranspiration. Because evapotranspiration can be estimated based on other meteorological conditions, the context may suggest that evapotranspiration is not included in the meteorological data. Meteorological data can include data reflecting actual conditions (current and/or historical) and data reflecting forecast conditions. The forecast is a prediction about what the meteorological condition will be at a future time, typically made when the condition is unknown, e.g., one half, one or more days in advance.

It should be noted that the term irrigation controller is used herein to denote various devices used to turn on and off an automatic irrigation system, and variants or evolutions thereof. Irrigation controllers typically are devices which can be very simple to extremely sophisticated computerized devices that can utilize wireline and/or wireless communication, e.g., modems, cellular telephones, and/or radios and allow communication between the irrigation controller and the units (valves, meters, weather stations, soil moisture sensors, etc.) being controlled, and/or communication between irrigation controllers and/or servers. An irrigation controller can be a stand-alone controller, a satellite controller with valve control and/or various sensor interfaces, and/or a combination thereof. One or more satellite controllers can be provided with a user interface for local programming. One or more embodiments can provide for irrigation controllers which are networked, where the irrigation controllers can communicate with each other.

The term server is used herein to denote various devices can be used to control one or more irrigation controllers, and variants or evolutions thereof. Servers typically are general purpose computers, personal computers, handheld and/or portable computer devices, peer-to-peer irrigation controllers, or the like, which can utilize wireline and/or wireless communication, e.g., modems, cellular telephones, and/or radios and allow communication between the server and irrigation controller(s). The server can communicate with other servers, according to various embodiments, e.g., another server having the meteorological database.

Furthermore the irrigation controllers and/or servers of interest may have short range wireless communications capability normally referred to as WLAN (wireless local area network) capabilities, such as IEEE 802.11, Bluetooth, or Hiper-Lan and the like using, e.g., CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol/Universal Protocol), IPX/SPX (Inter-Packet Exchange/Sequential Packet Exchange), Net BIOS (Network Basic Input Output System) or other protocol structures. Alternatively the irrigation controllers and/or servers may be equipped with wireless communication and may be connected to a LAN using protocols such as TCP/IP, UDP/UP, IPX/SPX, or Net BIOS via a hardwired interface such as a cable and/or a connector.

What is claimed is:

1. An irrigation controller, comprising:
a receiver; and
a processor, the processor being configured to facilitate receiving, in accordance with the receiver, an indication of rainfall which is forecast to fall on at least one location; first determining a minimum allowable water level and an optimal water level at the at least one location; second determining water available at the at least one location; and third determining an amount of water to be delivered so that the water available and the forecast rainfall exceed the minimum allowable water level, and avoid exceeding the optimal water level.

2. The device of claim 1, further comprising at least one watering device, wherein the processor is further configured to facilitate the delivery of the amount via the watering device.

3. The device of claim 1, wherein the processor stores an indication of its location, which is utilized as the at least one location.

4. The device of claim 1, wherein, when the forecast rainfall indicates rain within the next plurality of days, the third determining includes judging the amount of water over the plurality of days.

5. The device of claim 1, further comprising at least one transmitter, wherein the processor is further configured to facilitate causing the transmitter to transmit a request for a forecast, responsive to a schedule.

6. The device of claim 1, wherein the processor is configured so that, if no rainfall is forecast, the amount to be delivered is calculated to restore the optimal water level.

7. The device of claim 1, wherein, if the evapotranspiration level will reduce the water available to at least the minimum allowable water level, a watering schedule is adjusted to deliver the minimum allowable plus a maximum evapotranspiration loss.

8. A computer-readable medium comprising instructions for execution by a computer, the instructions for implementing a computer-implemented method for delivering water via one or more irrigation devices at one or more locations, the instructions for implementing the steps of:
(A) receiving an indication of a meteorological condition which is forecast to occur on at least one location;
(B) determining a minimum allowable water level and an optimal water level at the at least one location;
(C) adjusting a watering schedule at the at least one location, responsive to the meteorological condition, so that water available in relation to the meteorological condition exceeds the minimum allowable water level and avoids exceeding the optimal water level; and
(D) facilitating the delivery of an amount of water via the one or more irrigation devices to the at least one location responsive to the watering schedule.

9. The medium of claim 8, wherein, if the meteorological condition indicates that no rainfall is forecast, the amount is calculated to restore the optimal water level.

10. The medium of claim 8, further comprising instructions for determining the water available at the at least one location.

11. The medium of claim 10, wherein, if the evapotranspiration level will reduce the water available to at least the minimum allowable water level during the watering schedule, the watering schedule is adjusted to deliver the minimum allowable plus a maximum evapotranspiration loss.

12. The medium of claim 10, wherein the water available is determined to be a water available for the previous time period minus the evapotranspiration loss plus an amount of actual rainfall.

13. The medium of claim 12, further comprising receiving an indication of the amount of actual rainfall.

14. The medium of claim 12, further comprising receiving an indication of evapotranspiration loss.

15. The medium of claim 10, wherein the water available is determined responsive to at least one sensor at the at least one location.

16. The medium of claim 8, wherein the delivery is during a particular day in the watering schedule, and the forecast meteorological condition is for at least one day subsequent to the particular day in the watering schedule.

17. A system for facilitating irrigation, comprising:
(A) a transmitter; and
(B) a processor, the processor being configured to facilitate obtaining indications of rainfall which is forecast to fall on a plurality of locations; determining a plurality of controllers and locations corresponding thereto; and transmitting, in accordance with the transmitter, the indications of forecast rainfall specific to the locations to the corresponding controllers.

18. The system of claim 17, wherein the processor is further configured to facilitate first determining a minimum allowable water level and an optimal water level at at least one of the locations corresponding to at least one of the controllers; second determining water available at the at least one location; and third determining an amount of water to be delivered so that the water available and the forecast rainfall exceed the minimum allowable water level, and avoid exceeding the optimal water level, at the at least one location.

19. The system of claim 18, further comprising a receiver, wherein the processor receives, in accordance with the receiver, an indication of the water available.

20. The device of claim 18, wherein, when the forecast rainfall indicates rain within the next plurality of days, the third determining includes judging the amount of water over the plurality of days.
